(19) United States
(12) Patent Application Publication
(10) Pub. No.: US 2014/0032279 A1
(43) Pub. Date: Jan. 30, 2014

(54) METHOD OF MANAGEMENT HUMAN RESOURCE DEVELOPMENT

(71) Applicants: Giulia Zanichelli, Torino (TO) (IT); Giacomo Castri, Torino (TO) (IT); Massimiliano Daniele, Torino (TO) (IT)

(72) Inventors: Giulia Zanichelli, Torino (TO) (IT); Giacomo Castri, Torino (TO) (IT); Massimiliano Daniele, Torino (TO) (IT)

(21) Appl. No.: 13/557,312

(22) Filed: Jul. 25, 2012

(51) Int. Cl. G06Q 10/10

(52) U.S. Cl. CPC G06Q 10/1053
USPC 705/7.42; 705/321

(57) ABSTRACT

A method of management human resource development in a working environment comprising a plurality of employees is provided. The method comprises receiving input data from an employee, wherein input data are indicative of an interest of the employee to a career development; generating a personal profile from the input data; screening the personal profile to determine if the employee is suitable for assessment; if the result of screening is positive, assessing the employee to assign a first score associated with a development attitude of the employee and a second score associated with the current role mastering; storing, in the computer, first and second scores as entries in a two-dimensional development matrix covering an area, and determining if the stored entries are positioned within a talent sub-area defined within the development matrix area.

### FIELD

The invention generally relates to techniques for managing the development of human resources within a working environment, in particular within a structured working environment. The invention is applicable to human resources management systems in general and in particular to development and assessment tools of human resources.

### BACKGROUND

Within a company, staff development is often encouraged through training, which is made available to an employee either following a recommendation from a more senior employee or as a step in a pre-arranged career path.

Internal vertical or transversal mobility frequently takes place through job posting that represents a channel for filling open positions in functions within the organisation. In the job posting, the head of a function informs the human resource (HR) department about his/her needs to fill an open position. The HR department announces the open position, for example by publishing the job posting on the company intranet, and invites interested candidates to apply.

In the development model according a pre-arranged career path, an employee follows subsequent steps of increasing complexity and/or responsibility until a certain professional level that the competent department, generally the HR department, has evaluated to be his/her target level.

The Applicant has noted that, in the development model according to a pre-arranged career path, which frequently envisages training courses, a risk exists that the company invests on an employee who is not interested in a professional growth exceeding his/her current level or exceeding a level that the employee has set as his/her personal target.

### Investment on Such Employees Costs

In the model of internal mobility advertised by posting, the candidate's motivation can be assumed. Once applications have been received, the HR department begins a screening of the responders to the job post and then carries out an assessment process of the prospective candidates. The Applicant has observed that the assessment process can be dispersive as some or many of the responders may result to be unfit for the job or there is a risk that an ideal candidate has not entered the job posting mechanism while being potentially interested and fit to the task.

The Applicant has further noticed that it is generally difficult to determine when an employee has developed the skills for committing to higher responsibilities or to an enlargement of tasks within the same function.

### SUMMARY

According to an aspect consistent with the present disclosure, a method of management human resource development in a working environment comprising a plurality of employees is presented, the method comprising:
storing in a computer a plurality of work levels, each work level being associated to a complexity of tasks to be accomplished by an employee of the plurality of employees;
associating, in the computer, personal data of each employee of the plurality of employees with a work level of the plurality of work levels;
providing, by the computer, at least one template to an employee of the plurality of employees, the at least one template having a field format defining data entry and comprising a query inviting the employee to provide information indicative of an interest of the employee to a career development;
receiving, in the computer, input data from the employee into the at least one template in reply to the query;
checking, by the computer, if input data received by the employee are complete; if input data are determined to be complete, assigning, by the computer, a complete status to the input data and a candidate status to the employee associated with input data having a complete status;
generating, by the computer, a personal profile based on the input data for each employee having a candidate status and on personal data associated with the work level of that employee;
retrieving, by the computer, for each personal profile, a current growth level;
screening, by the computer, the personal profiles so as to determine if the current growth level of a personal profile exceeds a growth threshold stored in the computer and being associated with the work level of that personal profile;
grouping, by the computer, in an assessment group personal profiles associated with each work level and having a current growth level exceeding the growth threshold of that work level so as to generate an assessment group for each work level;
receiving, in the computer, a first score associated with a development attitude and a second score associated with a current role mastering for an employee having a personal profile in an assessment group, the first and second score being the result of an assessment procedure on that employee;
creating, by the computer, for each assessment group, a two-dimensional development matrix covering an area and having as entries matrix points having as coordinates the first score and the second score;
defining, by the computer, a talent sub-area as part of the development matrix area defined by the points having as coordinates a first score larger than a threshold development attitude score and a second score larger than a threshold current role mastering, and
determining, by the computer, if the matrix point having as coordinates the stored entries associated with that personal is positioned within the talent sub-area.

Preferably, the working environment is a structured working environment in which a plurality of employees work within an organisational structure.

In an embodiment, the method further comprises:
dividing, by the computer, the development matrix into a plurality of grid-shaped sub-areas, and
clustering, by the computer, a plurality of entries, each entry being associated with a personal profile in an assessment group, so as to form a plurality of performance clusters associated with sub-pluralities of employees of the assessment group.

In an embodiment, the method further comprises:
generating a job opening within the working environment;
assigning to the job opening a required work level and required first and second scores and entering in the computer the required first and second scores;
associating, by the computer, the required first and second scores to an entry of the development matrix;
retrieving, by the computer, entries from the performance cluster containing the entry associated to the job opening and associating the entries with the respective personal profiles, and
screening, using the computer, the retrieved entries in order to select candidates suitable for the job opening.

In an embodiment, the first score is determined from a first pluralities of capability values and the second score is determined from a second plurality of capability values by using an automatic skill gap analysis, the first and second plurality of capability values resulting from the assessment procedure and being stored in the computer.

In an embodiment, retrieving a current growth level comprises retrieving a performance score and a motivational driver score associated with personal data of the employee, and screening the personal profiles comprises creating, by the computer, a two-dimensional screening matrix having as entries the performance score and the motivational driver score, and evaluating, by the computer, if the performance score and the motivational driver score exceeds a threshold performance score and a threshold motivational driver score, wherein the growth threshold is represented by a two-dimensional coordinate in the screening matrix.

Preferably, providing at least one template to an employee comprises providing a plurality of templates rendered to the employee, each of the plurality of templates having a field format comprising a field to be filled in so as a plurality of fields is rendered to the employee; receiving comprises receiving input data filled in the plurality of fields, and checking if input data are complete comprise selecting from the plurality of fields a sub-plurality of required fields and determining if input data are entered in at least the required fields.

According to a further aspect consistent with the present disclosure, a method of management human resource development within a working environment with a plurality of employees is presented, the method comprising:
providing, by the computer, at least one template to an employee, the at least one template having a field format defining data entry and comprising a query inviting the employee to provide information indicative of an interest of the employee to a career development;
receiving, in the computer, input data from the employee into the at least one template according to the field format in reply to the query;
checking, by the computer, if input data received by the employee are complete; if input data are determined to be complete, assigning, by the computer, a complete status to the input data and a candidate status to the employee associated with input data having a complete status;
generating, by the computer, a personal profile based on the input data for each employee having a candidate status;
retrieving, by the computer, for each personal profile, a current growth level;
screening, by the computer, the personal profiles so as to determine if the current growth level of an employee having a candidate status exceeds a growth threshold stored in the computer and associated with the personal profile;
grouping, by the computer, in an assessment group employees having a candidate status and a current growth level exceeding the growth threshold;
receiving, in the computer, a first score associated with a development attitude and a second score associated with a current role mastering for an employee having a personal profile in the assessment group, the first and second score being the result of an assessment procedure on that employee;
creating, by the computer, a two-dimensional development matrix covering an area and having as entries matrix points having as coordinates the first score and the second score, and
determining if the stored entries are positioned within a talent sub-area defined within the development matrix area.

Preferably, the working environment is a structured working environment in which a plurality of employees work within an organisational structure.

In an embodiment, the method further comprises, after determining if the stored entries are positioned in the talent sub-area, selecting, by the computer, entries located within the talent sub-area and displaying, by the computer, personal profiles of employees associated with those entries so as to select employees suitable for professional growth.

In an embodiment, retrieving a current growth level comprises retrieving a performance score and a motivational driver score associated with personal data of the employee, and screening the personal profiles comprises creating, by the computer, a two-dimensional screening matrix having as entries the performance score and the motivational driver score, and evaluating, by the computer, if the performance score and the motivational driver score exceeds a threshold performance score and a threshold motivational driver score, wherein the growth threshold is represented by a two-dimensional coordinate in the matrix.

In an embodiment, the first score is determined from a first pluralities of capability values and the second score is determined from a second plurality of capability values by using an automatic skill gap analysis, the first and second plurality of capability values resulting from the assessment procedure and being stored in the computer.

### BRIEF DESCRIPTION OF THE DRAWINGS

Reference will now be made in detail to some preferred embodiments consistent with the present disclosure, examples of which are illustrated in the accompanying drawings.

FIG. 1 is a block diagram showing a networked computing environment in which an embodiment consistent with the present disclosure may be implemented.

FIG. 2 is a diagram showing the content of input data to be inserted by an employee by means of the self-assessment tool, in an embodiment consistent with the present disclosure.

FIG. 3 is a graphical representation of an exemplary screening matrix in an embodiment consistent with the present disclosure.

FIG. 4 is a graphical representation of an exemplary development matrix in an embodiment consistent with the present disclosure.

FIG. 5 is a flow chart showing how management of human resources development is provided in an embodiment consistent with the present disclosure.

FIG. 6 is a diagram showing a work level structure in an embodiment consistent with the present disclosure.

FIG. 7 is a block diagram showing a networked computing environment in which a further embodiment consistent with the present disclosure may be implemented.

FIG. 8 is a flowchart showing how management of human resources development is provided in a further embodiment consistent with the present disclosure.

### DESCRIPTION OF PREFERRED EMBODIMENTS

Within the present description, the term “company” will be used in a broad and generic sense indicating in general a structured working environment in which a plurality of individuals work in different functions and with different tasks within an organisational structure, including for example institutions, such as financial institutions, banks, manufacturing enterprises and retail firms.

In the following description and claims, the term “employee” is to be read in the broad and generic sense to encompass all individuals having employer-employee relationships, generally but not exclusively having a permanent or long-term contract with the employer and without limitation of the type of contract.

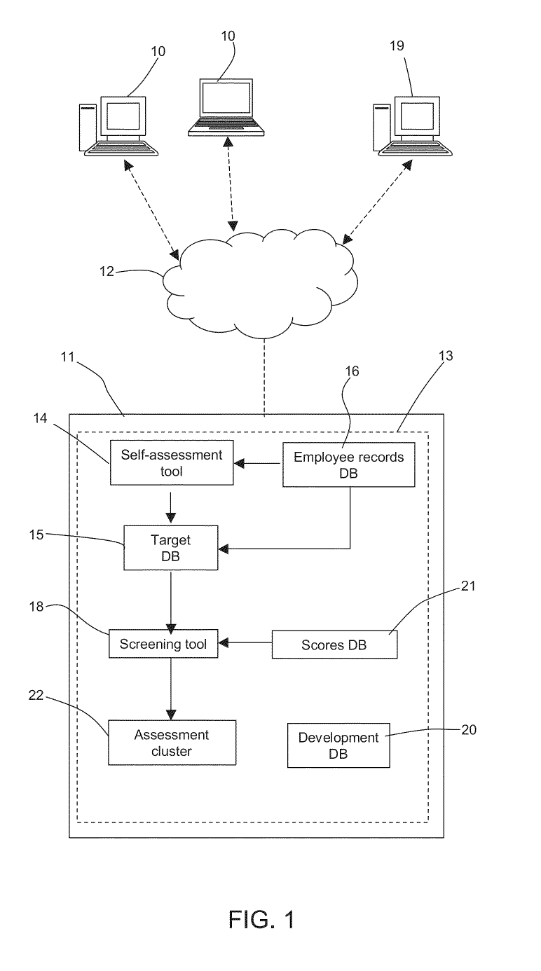

FIG. 1 is a block diagram of a networked computing environment in which an embodiment consistent with the present disclosure may be implemented. A plurality of workstations 10 are connected to a server 11 via a communication network 12. Communication network 12 may include one or more wired and/or wireless and/or mobile telecommunication systems or networks, local area networks, the Internet, etc.

Within the networked computing environment a development management system 13 is implemented as a software tool providing high-level application programs. In a client-server architecture, the application programs can be run on the server 11 connected to the user terminals (e.g. workstations) or they can be distributed across a plurality of servers (not shown in the figure). Modules within the development management system described in the following are components or parts of the software tool providing high-level application programs which include database applications, mathematical algorithms, and software infrastructure connecting various software components.

The development management system comprises a self-assessment tool 14 apt to receive input data from users, i.e. employees, and to process the input data so as to generate a personal profile based on the input data. Within the company, a plurality of employees have access to the self-assessment tool that produces a template, and generally a plurality of templates, comprising a query and rendered to the users through an application user interface. The query provides questions and/or topics inviting an employee to provide information (i.e. input data) indicative of an interest of to a career development.

Input data are introduced by users in the usual way, e.g. through an application user interface connected to and/or communicating with input applications, such as a Web browser user interface implemented through a visualisation unit (e.g. display) and an input unit (e.g. keyboard, touch screen, etc.) of the workstations. For example, employees can access to the self-assessment tool by clicking a “Tell me about you” link allocated on a page within a company Intranet.

In some preferred embodiments, the template has a field format defining data entry requirements and contains open questions and/or topics titles to be filled-in in specific fields. Preferably, a plurality of templates are sequentially rendered to the employee, each template pertaining to a question or topics inviting the employee to provide an answer.

The self-assessment tool 14 is apt to tag as required fields a plurality of fields and to check if input data are entered in the required fields (and thus if a compulsory information has been received by the employee). If the required field completion is determined, i.e., if the result of checking is in the positive, the self-assessment tool is structured to assemble and to organise the input data so as to generate a personal profile for each employee who has completed the self-assessment procedure and to transmit the personal profile to a target database (DB) 15 comprised in the development management system 13. The target database stores the personal profiles.

In an embodiment, if the result of checking is in the positive, the self-assessment tool assigns to the data forming the personal profile a “candidate” status (e.g. by attaching a tag to the data). If the result of checking is in the negative, the self-assessment tool can discard the input data received from the employee or store the data, e.g. in the target database, by assigning them a “non candidate” status so as they will not be considered by the system in further procedures (e.g. screening, assessment, etc.), at least until input data are completed and consequently the status of the data can switch to a candidate status.

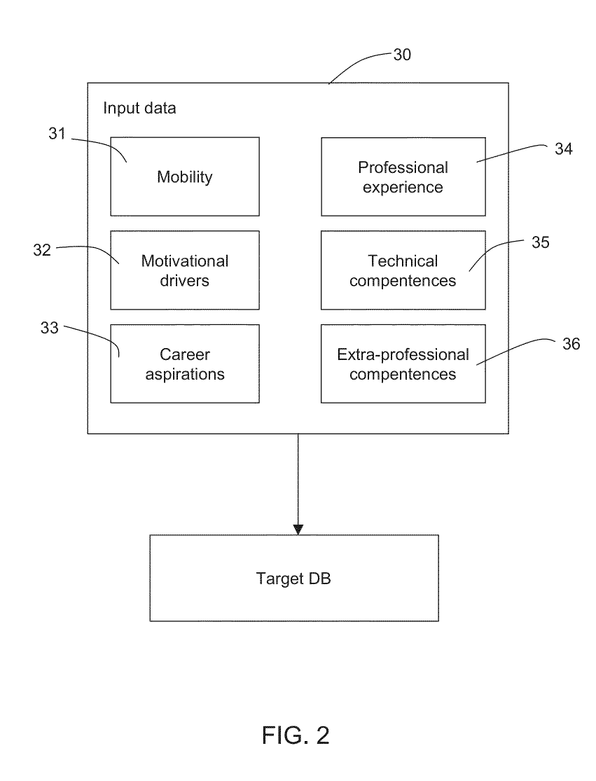

FIG. 2 is a diagram showing the content of input data to be inserted by an employee by means of the self-assessment tool, in an embodiment consistent with the present disclosure. According to this embodiment, input data 30 comprise:
data related to the mobility 31, in particular to the propensity to a change of location and, possibly, to a move within the organisation;
data related to career aspirations 33, including information about the desire to advance and/or to what a next position should offer. The template(s) dealing with this topics can for example contain free text fields headed by a generic question, such as “In what would you like your next position should be different from your current one?”, “What are your mid-term goals?”, etc., and
data related to motivational drivers 32. Preferably, for the input of data related to motivational drivers, employees are invited to complete a questionnaire based on a careers anchor model originally developed by Edgar Schein.

Optionally, input data include:
data related to external professional experience 34. The employee is invited to fill in possible professional experience outside the company, for example related to jobs prior to join the company;
data related to technical competencies 35, regarding information to the technical or intellectual knowledge and skills required to perform a particular job or occupation, and
data related to extra-professional experience 36, including information on other experiences not related to the current job, for example pertaining to skills developed in hobbies.

Preferably, the self-assessment tool is set so that input data are considered completed if data related to the mobility, career aspirations and motivational drivers are filled in by the employee, e.g. by inserting input data in required fields in one or more templates rendered to the employee by the self-assessment tool.

Referring back to FIG. 1, in some preferred embodiments, the self-assessment tool interacts with an employee records database 16, which stores data related to the in-house professional experience of employees from the moment they joined the company. Data include the current role of each employee and its job description and the current place of employment (companies such as medium-size banks typically have offices at various locations across a large geographical area). Possibly, data further include the name of the senior employee to whom the employee reports. Data related to in-house professional experience and thus records in database 16 are generally entered by the HR department of the company, e.g. through one or more workstations 19. Some of the data stored in the employee records database can be visible to the employee who has accessed the self-assessment tool as a template showing a summary of his/her in-house personal experience. The employee records database can be part of the development management system 13 (as shown in FIG. 1) or it can interact with it as an external application (not shown in the figures).

Each personal profile of the target DB is associated with a role defining the current job or position of the employee. Roles can be coded e.g. with a one or more digit code or alpha-numerical code in accordance with a job code classification. Roles of employees can be a data available in the employee records database 16 and can be indexed in the target database 15 so that, in the target database, each personal profile is associated to a role.

The development management system 13 comprises a screening tool 18 apt to retrieve from the target database 15 a personal profile and its associated role, to store growth threshold scores for the retrieved role, to receive scores associated with the current growth level of the employee having that personal profile, and to determine if the received scores exceed the growth threshold scores. In an embodiment, scores are retrieved by the screening tool from a score database 21 that may be linked to or merged with the employee records database 16.

Preferably, scores associated with the current growth level comprise a performance score and a motivational driver score. In some preferred embodiments, the screening tool 18 is apt to create a two-dimensional matrix, herein referred to as the screening matrix, having as entries a performance score and a motivational driver score relative to each personal profile stored in the target database 15. Entries are retrieved from score database 21. The growth threshold is represented by a point in the matrix having as coordinates a threshold performance score and a threshold motivational driver score. If both the performance score and the motivational driver score are larger than the threshold performance score and a threshold motivational driver score, respectively, the screening is determined to have a positive result.

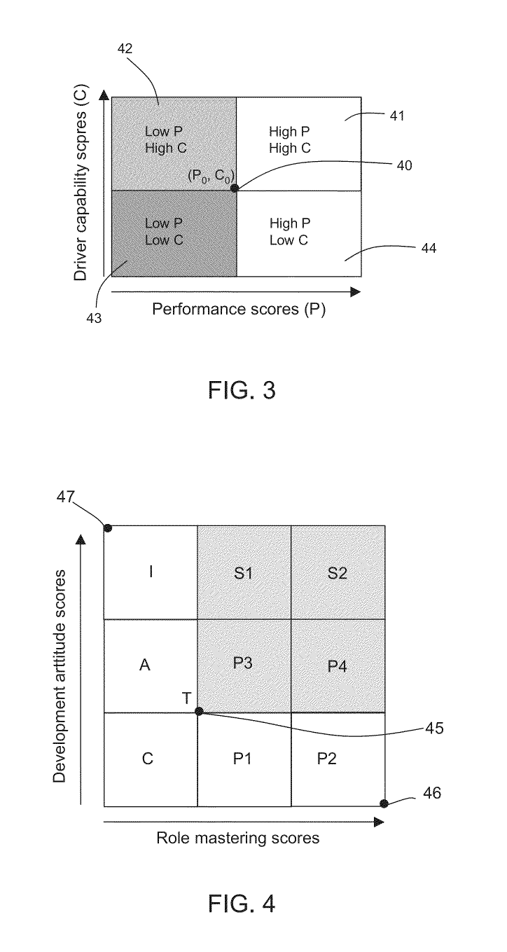

FIG. 3 is a graphical representation of an exemplary screening matrix in an embodiment consistent with the present disclosure. The growth threshold is represented in the matrix by two-dimensional point 40 having as coordinates (P₀,C₀,). Matrix points that have either the performance score or the motivational driver score respectively lower than P₀ and C₀ are determined to be associated with a negative result of the screening. In the embodiment of FIG. 3, the matrix area is divided in four sub-areas, namely 41 to 44 so that the matrix is represented by a 2×2 box grid, each box contacting the point (C₀, P₀). Personal profiles associated to points in sub-areas 42 to 44 are determined by the screening tool to have failed the screening procedure, whereas employees associated to points in sub-area 41 are determined by the screening tool to have successfully passed the screening procedure (positive result).

In an embodiment, the performance score used as entry in the screening matrix is calculated by the screening tool by making a weighted average over a first performance value attributed to the last working year of the employee and a second performance value attributed to the year preceding the last year, wherein the first performance value is weighted by a factor 0.7 and the second performance value is weighted by a factor 0.3. First and second performance values can be determined by taking the results achieved in the reference year with respect to a target result. First and second performance value can be retrieved by the screening tool from the score database 21.

In an embodiment, the motivational driver score is determined, e.g. by the HR department, after analysis of a report provided by the person to whom the employee refers to. The report can be for example formed by the answers to an on-line questionnaire filled in by the responsible person. The motivational driver score can be inserted by a user, e.g. of the HR department, in the score database.

Employees associated to the personal profiles that are determined by the screening tool to have a positive result are invited by the competent department within the company, e.g. the HR department, to undergo an assessment procedure aimed to evaluate the propensity for development of the employees. The Applicant has realised that, in order to assess with large accuracy motivation and skills of an employee, besides propensity for development, assessment should advantageously take into account the mastering of the current role of that employee.

Personal profiles having positive results from the screening process are automatically selected and grouped, by the screening tool, in an assessment group (or cluster) of personal profiles formed by a sub-group of the group of the personal profiles of the target database. In the embodiment of FIG. 1, the screening tool 18 transmits to or otherwise stores in an assessment cluster database 22 within the development management system 13 the personal profiles having positive result from the screening. The assessment cluster DB has as records the personal profiles associated with employees who have growth scores larger than growth threshold.

In other embodiments, an assessment cluster is created by the screening tool by tagging or indexing the personal profiles having scores above threshold in the target database so that records associated to those profiles can be selected and/or grouped within the target database.

The assessment procedure following the screening process can be carried out by means of different methodologies and selection of a methodology can depend on the role associated to a personal profile. Examples of methodologies can be based on a fast evaluation of the answers provided to an on-line questionnaire or on role plays and simulations aimed to predict the on-the-job performance of an employee.

Results from the assessment procedure are evaluated by the HR department or other competent departments within the company and, following the evaluation, for each employee who went through the assessment procedure, a first score indicative of a development attitude and a second score indicative of the mastering of the current role of the employee are inserted in a development database 20 within the development management system 13.

Optionally, besides the first and second scores, a verbal summary of test results can be entered in the development database 20.

Both first and second scores are associated to individual capabilities of an employee having a personal profile in the assessment group. The first score is referred also to as the development attitude score and is associated on capabilities related to growth potential of that employee.

The second score is indicative of how skills and knowledge are used to perform the current job and herein referred also to as the role mastering score. The second score generally pertains to intrinsic or transverse capabilities that an employee possesses independently of the role complexity of the current position or of the growth potential.

First score is determined on the basis of a first plurality of capability values and second score is determined on the basis of a second plurality of capability values, both first and second pluralities of capability values resulting from the assessment procedure. In an embodiment, first and second scores are calculated from the respective first and second plurality of capability values by using techniques of skill gap analysis to determine the gap between ideal capability values and values of capabilities resulting from the assessment.

In an embodiment, the development database 20 provides a template for each employee to be filled in by users involved in the assessment of that employee, usually staff of the HR department, e.g. by inserting in specific fields the first and second pluralities of capabilities. The development database stores a first and second plurality of target values of ideal capabilities (i.e. the ideal or required capabilities for that role) and embodies or is linked to a gap analysis tool (not shown in the figure). The gap analysis tool is apt to calculate first difference values between each capability value of the first plurality of capability values and the respective first target capability value and to determine a first score (development attitude score) from the first difference values related to the first plurality of capabilities; and to calculate second difference values between each capability value of the second plurality of capability values and the respective second target capability value and to determine a second score (role mastering score) from the second difference values related to the second plurality of capabilities. In embodiment, the first score is calculated as an average value of the difference values between the first plurality of capabilities and the first plurality of target capability values and the second score is calculated as an average value of the difference values between the second plurality of capabilities and the second plurality of target capability values.

The development attitude score and the role mastering score stored in the development database are arranged by the development DB 20 as entries of a two-dimensional development matrix, wherein each point of the matrix is associated to a personal profile of an employee who has concluded the assessment procedure. The position of a point within the development matrix created by the DB 20 is indicative of the growth potential and role mastering of the personal profile (i.e. employee) associated with that point.

Preferably, the total area of a development matrix defined in length and breadth by a maximum development attitude score and a maximum role mastering score, respectively, is divided in a plurality of sub-areas, each sub-area being indicative of a level of capabilities related to growth potential and role mastering.

In some preferred embodiments, at least one talent sub-area is defined in the development matrix, and employees associated with entries within that talent sub-area area are eligible for vertical growth or promotion.

FIG. 4 is a graphical representation of an exemplary development matrix in an embodiment consistent with the present disclosure. The matrix area is divided in nine equal sub-areas, each area being indicative of the potential of employees for professional growth. In the example sub-areas are:
Sub-area C (critical): associated with under performer employees with low potential for job enlargement and further professional growth;
Sub-area A (further analysis needed): associated with employees with a fair growth potential but not completely fit to the assigned role;

Sub-area I (worth investing): associated with employees having a high growth potential, which is however not represented in the current role (e.g. they are new in the role);
Sub-area P1 (performer): associated with plain performers with low growth potential;

Sub-area P2 (expert performer): associated with employees with low growth potential and high role mastering, for whom no further investment (e.g. training) is needed;
Sub-area P3 (senior performer): associated with employees with capability of growing within the organisation, suitable for job enlargement;
Sub-area P4 (high-potential performer): associated with employees with role mastering exceeding expectations of the current role and good growth potential;
Sub-area S1 (rising star): high growth potential employees with good role mastering, and
Sub-area S2 (star): associated with high-potential employees with role mastering exceeding expectations of the current role.

In the example of FIG. 4, each sub-area is automatically defined by defining an area from a maximum role mastering score 46 and a maximum development attitude score 47 and then divide the area into nine equal sub-areas. Personal profiles are clustered in a plurality (in this case nine) of performance clusters.

Preferably, a threshold role mastering score and a threshold development attitude score are stored, those scores being indicative of a threshold growth potential. In FIG. 4, the threshold is represented by point T indicated with referral number 45. A talent sub-area is defined within the area of the matrix by merging sub-areas P3, P4, S1 and S2 (shown in FIG. 4 by the grey area of the matrix grid) formed by matrix points having coordinates larger than a threshold role mastering score and a threshold development attitude score.

In some embodiments, the talent sub-area forms a batch of high performance employees who are eligible for vertical growth towards roles of higher complexity.

It is noted that by creating a batch of highly performing employees the company organisation has the possibility of detecting needs ahead of the creation of a vacancy within a function or at least, when an open position turns up, of reducing the risk that the best suited person is not included in the candidates for the open position.

In addition, since the personal profiles of all employees having gone through the self-assessment procedure and having passed the screening process can be included in the development matrix, the organization can readily evaluate if and how to invest in employees associated with a particular sub-area of the development matrix.

The method according to some embodiments consistent with the present disclosure comprises, after assessing a plurality of employees and generating a development matrix covering an area, selecting a sub-plurality of employees being associated with scores within a talent sub-area of the development matrix area.

By means of the self-assessment tool, an employee can put himself forward as a potential candidate for a career advancement or a job enlargement and the competent department (usually the HR department) can assume the motivation of that employee to move forward in his professional experience. Since employees who undergo the screening process are those who have completed the self-assessment procedure (i.e. they have a “candidate” status in the system), there is a low probability that the company invests on employees, for example by enrolling them in training courses, who are unwilling to advance.

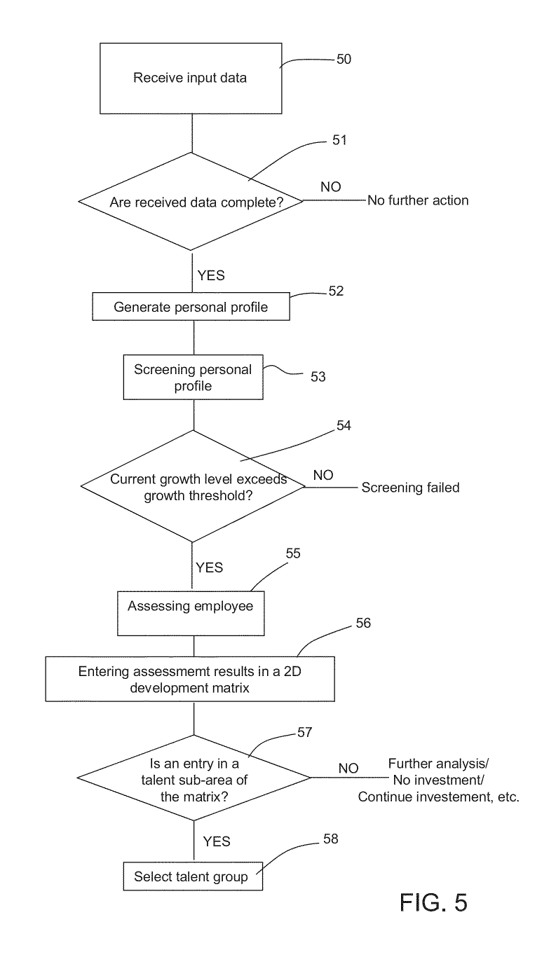

FIG. 5 is a flow chart showing how management of human resources development is provided in an embodiment consistent with the present disclosure. In 50, input data are received, in a computer, from an employee. The input data area indicative of an interest of the employee to a career development. Input data are checked to determine if they are complete, e.g. the employee has filled with information certain required fields (51). If input data are determined not to be complete, no further action is taken by the process. If input data are determined to be complete, a personal profile is generated for the employee associated to the input data (52). The personal profile undergoes to an automatic screening process (53) so as to evaluate if the employee has a current growth level indicative of performance and motivational driver which exceeds a pre-defined growth threshold (54).

If the growth level does not exceed the growth threshold, screening process provides a negative result. Preferably, an indication is provided by the system that the employee cannot proceed to an assessment procedure, e.g. by visualising a label “screening failed” on a display of workstation 19 of FIG. 1 from which users of the HR department are logged in the system. If the employee has a growth level exceeding the growth threshold, an assessment group (or cluster) of personal profiles is automatically created by the system and employees of the assessment cluster are assessed in order to assign each of them a first score associated with a development attitude of the employee and a second score associated with his/her current role mastering (55). First and second scores are stored in the development management system that generates a two-dimensional development matrix covering an area (56) and having as entries the first and the second scores associated with personal profiles included in the assessment cluster. A talent sub-area as part of the matrix area is automatically defined by the matrix points having a first score larger than a threshold first score and a second score larger than a threshold second score so as to determine if an employee has scores in the talent sub-area (57). Employees having scores in the talent sub-area are selected and grouped in a talent group of employees eligible for promotion to higher grade positions (58).

For employees having scores outside the talent sub-area, different actions can be decided, in dependence on the position of the point having as coordinates first and second scores in the development matrix. With reference to the embodiment of FIG. 4, no further investment can be decided for employees having matrix points in sub-areas C, P1 and P2, whereas further analysis and monitoring can be decided for employees in sub-areas A and I.

In the foregoing embodiments, each personal profile stored in the development management system is associated with or includes data related to the role currently covered by the employee having that personal profile. Within the company, roles are often allocated according to a grading structure. In some preferred embodiments consistent with the present disclosure, roles of employees are clustered in a plurality of work levels that group roles that require similar abilities and skills and/or similar capabilities of solving problems with similar complexity. In a preferred embodiment, the term “similar” is referred to a predetermined range of values defining complexity, ability, skill, etc.

In some preferred embodiments, a work level is based on a complexity of tasks to be accomplished by an employee in that level. Complexity may comprise a predefined range of complexity values associated to skills, competencies and level of decision making required to perform successfully in that level. The plurality of work levels may represent up and down the company organisation and how responsibility and activities varies through career. A higher work level entails a higher degree of complexity of tasks to be solved and it is often linked to higher grades. Moving from one level to the next is herein referred to as a level transition.

Preferably, roles of similar complexity are grouped in a work level independently of the job function served by the employees in the company. For example, a work level clusters employees having roles of similar complexity while having diverse job functions within the company, e.g. ranging from legal counseling, HR, R&D to business finance.

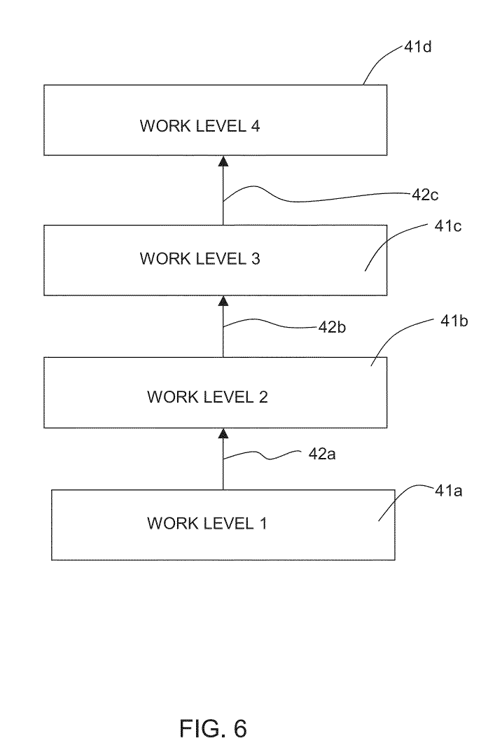

In an embodiment, the plurality of work levels consists of four work levels. FIG. 6 is a diagram showing a four work level grading structure according to an embodiment, namely:

Work level 1 (41a) of contributor, which aggregates roles that guarantee the execution of in relation to the service or product to be provided

Work level 2 (41b) of expert, which aggregates roles with professional or functional expertise necessary to take the work forward and to solve problems related to complex

Work 3 level (41c) of coordinator, which aggregates roles able to perform work activities with personal autonomy, accountability and supervisory responsibilities;

Work level 4 (41d) of manager, which aggregates roles with formal accountability of management of people, technology or intellectual knowledge and dealing with largely unpredictable and complex work activities (e.g. head of function, senior director, managing director, etc.).

Level transitions from a work level to the next higher work level are indicated in FIG. 6 with arrows 42a-42c.

Employees within the organisation can be clustered in fewer or more work levels. Career paths or segments of career paths can entail mobility within the same work level so as to acquire a higher seniority grade or job enlargement.

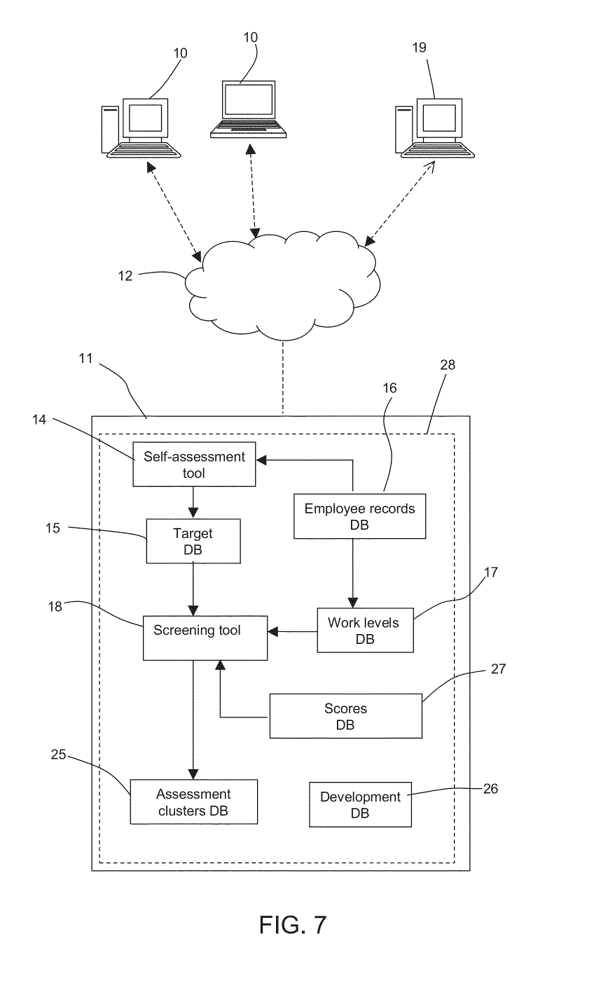

FIG. 7 is a block diagram showing a networked computing environment in which an embodiment consistent with the present disclosure may be implemented. Elements having similar functions as those described with reference to FIG. 1 bear the same reference numbers. In the present embodiment, the server hosts a development management system 28 that comprises a work levels database 17 in which roles of employees are grouped in work levels.

In an embodiment, information on the work level, and possibly the seniority grade within the work level, which are associated with an employee's role, is stored as a record containing personal data in the employee records database 16. Employees' role can be imported into the work level database 17 from the employee records database. Alternatively, databases 16 and 17 can be merged or a record of personal data associated to an employee in a database can be indexed in the other database. As described with reference to FIG. 1, the self-assessment tool 14 generates a personal profile of employees with self-assessment process having a complete status (i.e. the required input data have been received by the system) and transmit the personal profile to target database 15.

The screening tool 18 is apt to retrieve from the target database 15 a personal profile and its associated role, to receive scores associated to the current growth level of the employee having that personal profile from a scores database 27, to associate scores to a score threshold, and to determine if the received scores exceeds the score threshold. Preferably, scores comprise a performance score and a motivational driver score. Score thresholds, and in particular a threshold performance score and a threshold motivational driver score are defined in accordance with the work level which the role associated to the personal profile belongs to and are stored in the score database 27. Score database 27 may be linked to or merged with the employee records database 16 and/or to the work levels database 17.

In some preferred embodiments, the screening tool 18 is apt to create, for each work level, a two-dimensional screening matrix having as entries a performance score and a motivational driver score relative to each personal profile stored in the target database 15. Entries are retrieved from score database 27 storing score thresholds associated to each work level. The score threshold is represented by a point in the matrix having as coordinates a threshold performance score and a threshold motivational driver score. The screening matrix created for each work level can be represented by the screening matrix of FIG. 3 and employees associated to points in sub-area 31 are determined by the screening tool to have a positive result.

Performance and motivational driver scores can for example being taken as a numerical percentage with respect to a target value referred to a work level for an ideal candidate associated with that work level. For example, a threshold numerical percentage is taken as threshold score.

In an embodiment, the performance score used as entry in the screening matrix is automatically calculated by making a weighted average over a first performance value attributed to the last working year of the employee and a second performance value attributed to the year preceding the last year, wherein the first performance value is weighted by a factor 0.7 and the second performance value is weighted by a factor 0.3. Both first and second performance values are stored in the score database 27.

Personal profiles having positive results from the screening process may be grouped in a plurality of assessment clusters, each assessment cluster being associated to a respective work level. In the embodiment of FIG. 7, the screening tool 18 assembles the personal profiles who are determined to have positive result of the screening and generates a plurality of assessment clusters that are transmitted or otherwise stored by the screening tool in an assessment clusters database 25.

Personal profiles included in the assessment clusters database undergo to an assessment procedure. The assessment procedure can be carried out by means of different methodologies and selection of a methodology preferably depends on the work level considered. Results of the assessment procedure are evaluated by staff responsible of the assessment and a first score indicative of a development attitude and a second score indicative of the mastering of the current role of an employee are defined and inserted, by a user, in a development database 26 within the development management system 28.

In some embodiments, the development DB 26 generates a development matrix for each assessment cluster, and thus for each work level, so as to form a plurality of development matrices. In a preferred embodiment, each development matrix of the plurality of matrices is represented by a matrix described with reference to FIG. 4.

First score is determined on the basis of a first plurality of capabilities and second score is determined on the basis of a second plurality of capabilities, both first and second pluralities of capabilities resulting from the assessment procedure.

First and second plurality of capabilities are defined on dependence of the work level associated to the personal profile's role. Generally, the higher the work level, a larger number of capabilities and/or higher order capabilities are required.

With reference to the work level structure of FIG. 6 and according to an example, in the assessment for a level transition between work level 1 and work level 2 (42a), the first plurality of capability for calculation of the role mastering score consists of: analysis, building interpersonal relationships, team working, results-oriented approach and stress management. The second plurality of capabilities for the calculation of the development attitude score consists of: problem solving, understanding of client's needs, planning, taking initiative, and flexibility. Each of the first and second plurality of capabilities is associated to a target value of capability. Each capability is assessed in order to determine a capability value in relation to a target capability value (i.e. related to an ideal or required capability). The assessment procedure for a level transition from work level 1 to work level 2 is for example a fast assessment by answering an on-line questionnaire, which is then evaluated by the responsible staff to assign a capability value for each of the first and second plurality of capabilities.

An automatic skill gap analysis is performed based on the capabilities values resulting from the assessment, the analysis comprising: (1) receiving a first and a second plurality of capability values; (2) calculating a difference value (gap) between each capability value of the first plurality of capability values and a respective first target value of capability stored in the development DB; (3) calculating a first average difference value from the calculated difference values, the average difference value defining a first score associated with a development attitude; (4) calculating a difference value between each capability value of the second plurality of capabilities and a respective second target value of capability stored in the development DB, and (5) calculating a second average difference value from the calculated difference values, the average difference value defining a second score associated with the current role mastering. The calculated first and second score are entered automatically in a development matrix created by the development DB for work level 1.

As a further example of assessment of an employee having recorded a personal profile in the assessment cluster DB is provided with reference to the work level structure of FIG. 6 in relation to a level transition from work level 2 to work level 3 (42b). The following capabilities of an employee having a role in work level 2 are assessed:
a first plurality of capabilities consisting of: inclusion and diversity management, customer focus, organising and planning, negotiation skills, and results-oriented approach, and
a second plurality of capabilities consisting of: systemic view, motivation, credibility, self-awareness, resiliency, and lean thinking.

Capabilities are assessed by means of a group assessment in which employees are involved in role plays and simulations. An automatic skill gap analysis is performed following a procedure similar to that described with reference to the previous example in order to determine a first and a second score to be automatically entered in a development matrix associated to the second work level.

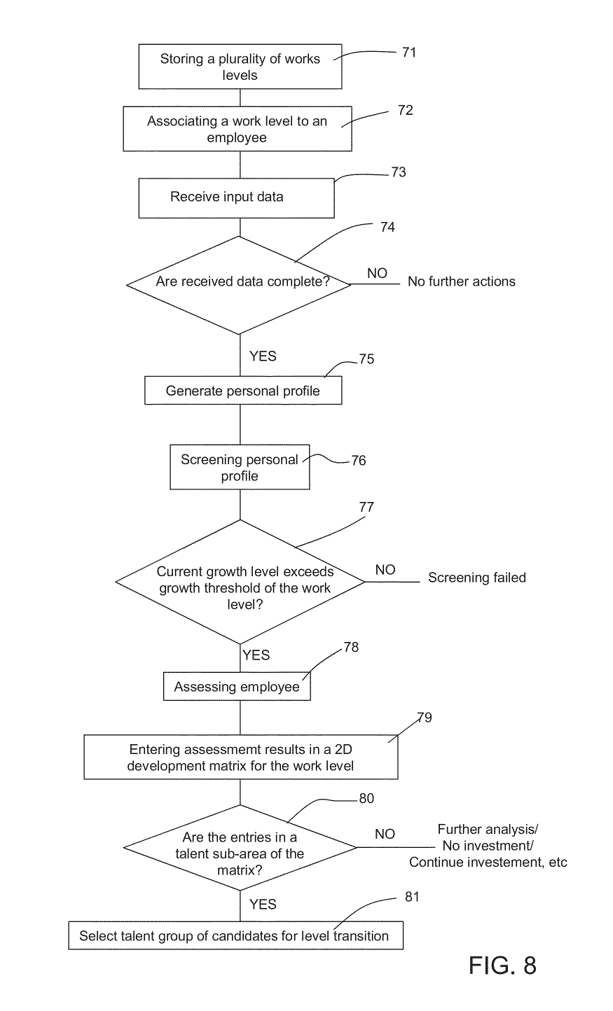

FIG. 8 is a flowchart showing how management of human resources development is provided in an embodiment consistent with the present disclosure.

A plurality of work levels are stored in a computer (71) and a plurality of employees within the company are grouped in the plurality of work levels so that each employee of the plurality is associated with a work level (72).

In 73, input data are received, in a computer, from an employee associated with a work level. The input data area indicative of an interest of the employee to a career development. Input data are automatically checked to determine if they are complete, e.g. the employee has filled with information certain fields required by the input data form (74). If input data are determined not to be complete, no further action is taken by the process, e.g. the system discards the incomplete input data. If input data are determined to be complete, a personal profile is generated for the employee associated with the input data (75). The personal profile undergoes to an automatic screening process (76) so as to evaluate if the personal profile has a current growth level indicative of performance and motivational driver which exceeds a pre-defined growth threshold (77) associated with the work level of the personal profile.

If the growth level does not exceed the growth threshold, screening process is determined to have negative result. Preferably, an indication is provided by the system that the employee cannot proceed with the assessment procedure, e.g. by visualising a label “screening failed” on a display of workstation 19 of FIG. 7 from which users of the HR department are logged in the system.

If the employee is determined by the screening process to have a growth level exceeding the growth threshold, the personal profile is associated with an assessment cluster created for the work level of the personal profile and stored in the system. The employee associated with that personal profile undergoes an assessment procedure in order to assign a first score associated with a development attitude of the employee and a second score associated with his/her current role mastering, wherein the second score is based on the input data received from the employee (78). First and second scores are stored as entries in a two-dimensional development matrix covering an area (79) e being associated with the work level of the assessed employee. A talent sub-area as part of the matrix area is defined by automatically selecting matrix points having coordinates a first score larger than a threshold first score and a second score larger tan a threshold second score and it is automatically determined if an employee has scores in the talent sub-area (80). Employees having scores in the talent sub-area are automatically selected and grouped in a talent group of employees within the work level eligible for a level transition (81).

Employees having scores in sub-areas different from the talent sub-area can be evaluated to require further analysis, further investment by the company for their professional growth or, if development attitude scores are low, the company may decide that no further investment is needed.

Although specific embodiments have been illustrated and described herein, those of ordinary skill in the art appreciate that any arrangement, which is implemented to achieve the same purpose, may be substituted for the specific embodiments shown and fall within a scope represented by the appended claims. The specification and drawings are, accordingly, to be regarded in an illustrative rather than a restrictive sense.

What is claimed is:

1. A method of management human resource development in a working environment comprising a plurality of employees, the method comprising:
storing in a computer a plurality of work levels, each work level being associated to a complexity of tasks to be accomplished by an employee of the plurality of employees;
associating, in the computer, personal data of each employee of the plurality of employees with a work level of the plurality of work levels;
providing, by the computer, at least one template to an employee of the plurality of employees, the at least one template having a field format defining data entry and comprising a query inviting the employee to provide information indicative of an interest of the employee to a career development;
receiving, in the computer, input data from the employee into the at least one template in reply to the query;
checking, by the computer, if input data received by the employee are complete;
if input data are determined to be complete, assigning, by the computer, a complete status to the input data and a candidate status to the employee associated with input data having a complete status;
generating, by the computer, a personal profile based on the input data for each employee having a candidate status and on personal data associated with the work level of that employee;
retrieving, by the computer, for each personal profile, a current growth level;
screening, by the computer, the personal profiles so as to determine if the current growth level of a personal profile exceeds a growth threshold stored in the computer and being associated with the work level of that personal profile;
grouping, by the computer, in an assessment group personal profiles associated with each work level and having a current growth level exceeding the growth threshold of that work level so as to generate an assessment group for each work level;
receiving, in the computer, a first score associated with a development attitude and a second score associated with a current role mastering for an employee having a personal profile in an assessment group, the first and second score being the result of an assessment procedure on that employee;
creating, by the computer, for each assessment group, a two-dimensional development matrix covering an area and having as entries matrix points having as coordinates the first score and the second score;
defining, by the computer, a talent sub-area as part of the development matrix area defined by the points having as coordinates a first score larger than a threshold development attitude score and a second score larger than a threshold current role mastering, and
determining, by the computer, if the matrix point having as coordinates the stored entries associated with that personal profile is positioned within the talent sub-area.

2. The method of claim 1, further comprising:
dividing, by the computer, the development matrix into a plurality of grid-shaped sub-areas, and
clustering, by the computer, a plurality of entries, each entry being associated with a personal profile in an assessment group, in the plurality of grid-shaped sub-areas so as to form a plurality of performance clusters associated with sub-pluralities of employees of the assessment group.

3. The method of claim 2, further comprising:
generating a job opening within the working environment;
assigning to the job opening a required work level and required first and second scores and entering in the computer the required first and second scores;
associating, by the computer, the required first and second scores to an entry of the development matrix;
retrieving, by the computer, entries from the performance cluster containing the entry associated to the job opening and associating the entries with the respective personal profiles, and
screening, using the computer, the retrieved entries in order to select candidates suitable for the job opening.

4. The method of claim 1, wherein the first score is determined from a first pluralities of capability values and the second score is determined from a second plurality of capability values by using an automatic skill gap analysis, the first and second plurality of capability values resulting from the assessment procedure and being stored in the computer.

5. The method of claim 1, wherein:
retrieving a current growth level comprises retrieving a performance score and a motivational driver score associated with personal data of the employee, and
screening the personal profiles comprises creating, by the computer, a two-dimensional screening matrix having as entries the performance score and the motivational driver score, and evaluating, by the computer, if the performance score and the motivational driver score exceeds a threshold performance score and a threshold motivational driver score, wherein the growth threshold is represented by a two-dimensional coordinate in the screening matrix.

6. The method of claim 1, wherein:
providing at least one template to an employee comprises providing a plurality of templates rendered to the employee, each of the plurality of templates having a field format comprising a field to be filled in so as a plurality of fields is rendered to the employee;
receiving comprises receiving input data filled in the plurality of fields, and
checking if input data are complete comprises selecting from the plurality of fields a sub-plurality of required fields and determining if input data are entered in at least the required fields.

7. A method of management human resource development in a working environment with a plurality of employees comprising:
providing, by the computer, at least one template to an employee, the at least one template having a field format defining data entry and comprising a query inviting the employee to provide information indicative of an interest of the employee to a career development;
receiving, in the computer, input data from the employee into the at least one template in reply to the query;
checking, by the computer, if input data received by the employee are complete;
if input data are determined to be complete, assigning, by the computer, a complete status to the input data and a candidate status to the employee associated with input data having a complete status;
generating, by the computer, a personal profile based on the input data for each employee having a candidate status;
retrieving, by the computer, for each personal profile, a current growth level;
screening, by the computer, the personal profiles so as to determine if the current growth level of an employee having a candidate status exceeds a growth threshold stored in the computer and associated with the personal profile;
grouping, by the computer, in an assessment group employees having a candidate status and a current growth level exceeding the growth threshold;
receiving, in the computer, a first score associated with a development attitude and a second score associated with a current role mastering for an employee having a personal profile in the assessment group, the first and second score being the result of an assessment procedure on that employee;
creating, by the computer, a two-dimensional development matrix covering an area and having as entries matrix points having as coordinates the first score and the second score, and
determining if the stored entries are positioned within a talent sub-area defined within the development matrix area.

8. The method of claim 7, further comprising, after determining if the stored entries are positioned in the talent sub-area, selecting, by the computer, entries located within the talent sub-area and displaying, by the computer, personal profiles of employees associated with those entries so as to select employees suitable for professional growth.

9. The method of claim 7, wherein:
retrieving a current growth level comprises retrieving a performance score and a motivational driver score associated with personal data of the employee, and
screening the personal profiles comprises creating, by the computer, a two-dimensional screening matrix having as entries the performance score and the motivational driver score, and evaluating, by the computer, if the performance score and the motivational driver score exceeds a threshold performance score and a threshold motivational driver score, wherein the growth threshold is represented by a two-dimensional coordinate in the matrix.

10. The method of claim 7, wherein the first score is determined from a first pluralities of capability values and the second score is determined from a second plurality of capability values by using an automatic skill gap analysis, the first and second plurality of capability values resulting from the assessment procedure and being stored in the computer.
